(19) United States
(12) Patent Application Publication
(10) Pub. No.: US 2026/0234059 A1
(43) Pub. Date: Aug. 13, 2026

(54) Method for the Treatment of a Gypsum Recyclate

(71) Applicant: Knauf Gips KG, lphofen (DE)

(72) Inventors: Rauno Baese, Iphofen (DE); Thorsten Geschwandtner, Iphofen (DE); Michael Steinbauer, Iphofen (DE)

(21) Appl. No.: 19/156,238

(22) PCT Filed: Feb. 14, 2023
(86) PCT No.: PCT/EP2023/025064

§ 371 Date: Aug. 13, 2025

(51) Int. Cl. C04B 28/14; C04B 18/167; C04B 22/06; C04B 111/00; E04C 2/04

(52) U.S. Cl. CPC C04B 28/14; C04B 18/167; C04B 22/064; E04C 2/043; C04B 2111/0062; C04B 2201/20

(57) ABSTRACT

The present invention relates to a method for treating gypsum comprising siliconates, the treatment including the steps of stirring an aqueous gypsum suspension with a solution of an alkali metal and/or alkaline earth metal hydroxide having a pH of 10 or higher and separating the solid components from the aqueous gypsum suspension. By the treatment with alkali metal and/or alkaline earth metal hydroxide, the detrimental effects of siliconates on a later foam, which is prepared with the thus treated gypsum, is significantly reduced. The present invention further relates to methods of preparing foamed gypsum compositions and gypsum boards including such method, correspondingly prepared gypsum and gypsum boards, and a use of alkali metal and/or alkaline earth metal hydroxide solutions for inactivating siliconates in gypsum recyclates.

### CROSS-REFERENCE TO RELATED APPLICATION

This application is the United States national phase of International Patent Application No. PCT/EP2023/025064 filed Feb. 14, 2023, the disclosure of which is hereby incorporated by reference in its entirety.

### BACKGROUND OF THE INVENTION

### Field of the Invention

The present invention relates to a method for treating gypsum comprising siliconates, especially siliconates comprising Si—H bonds, the treatment comprising the steps of stirring an aqueous gypsum suspension with a solution of an alkali metal hydroxide and/or alkaline earth metal hydroxide having a pH of 8 or higher and separating the solid components from the suspension. The present invention further relates to methods of preparing foamed gypsum compositions and gypsum boards comprising such method, correspondingly treated gypsum and gypsum boards comprising treated gypsum, and the use of alkali metal and/or alkaline earth metal hydroxide solutions for inactivating hydrogen methyl siliconates in gypsum recyclates.

### Description of Related Art

A building material that is readily and cheaply available today is so-called FGD gypsum, meaning gypsum obtained from flue gas desulphurization of coal-fired power plants. FGD gypsum is obtained from the combustion of coal by reacting the exhaust gases from the combustion with a calcium oxide or calcium carbonate suspension, whereby the sulfur dioxide (SO₂) contained in the flue gas is first converted to sulfur trioxide (SO₃) in the presence of oxygen and then bound as calcium sulphate (CaSO₄).

However, many governments have decided to phase out coal-fired power generation in the coming years, so it is to be expected that FGD gypsum will become an increasingly scarce raw material. In order to still be able to meet the existing demand for gypsum building materials, the recycling of gypsum products will play an increasingly important role.

One problem encountered when gypsum demolition products are recycled is that many gypsum products, for example plasterboards, are treated with additives or contain additives that impart certain functionalities to the finished product. These additives, however, remain when demolition gypsum products are recycled by simply crushing them. The resulting recycled “raw” material has altered properties compared to quarried or synthetic gypsum as for example FGD gypsum. By way of example, plasterboards, are often treated with water-repellent additives to reduce the material's ability to absorb water. Such a treatment is described, for example, in DE 10 220 659 A1, in which a mixture of “H-siloxane” (i.e. organosiloxane containing Si-bonded hydrogen atoms) and starch ethers is added in the production of plaster bodies. Such H-siloxane has a disruptive effect on the use of recycled gypsum for making new gypsum boards, as it has a foam-destroying effect and leads to fluctuating building material and board properties in the production process of the boards (which are made of foamed gypsum compositions for weight reduction and better thermal insulation).

Thus, there is a need for the provision of gypsum recyclates made from recycled gypsum products containing siliconates, especially comprising Si—H bonds, or which have been produced by including such siliconates. Such gypsum recyclates shall be as comparable as possible to conventional natural or FGD gypsum in terms of their foam-forming properties. It is paramount that the gypsum recyclates can be processed analogously to non-recycled natural or FGD gypsum into products with properties that are as consistent as possible.

The present invention addresses this need.

### SUMMARY OF THE INVENTION

In the investigations underlying this application, it was surprisingly found that the defoaming effect of siliconates contained in recycled gypsum or gypsum treated with such siliconates can be minimized by treating the gypsum with a solution of alkali metal and/or alkaline earth metal hydroxides and in particular calcium hydroxide. Such treatment is relatively easy to realize by stirring the gypsum in such a solution for a sufficient time. Without wanting to be bound by theory, the inventors believe that Si—H bonds and possibly also easily cleavable Si—C bonds contained in the siliconates are converted to Si—OH by the action of the hydroxide, thereby increasing the solubility of the silicon components in the alkaline solution. In this way, the siliconates can either be dissolved in the alkaline solution and separated from the gypsum, or at least chemically modified to such an extent that they do no longer interfere in the re-use of such gypsum recyclates for the production of new building materials.

According to a first aspect, the present invention thus relates to a method for treating recycled gypsum comprising the steps of (i) stirring an aqueous gypsum suspension with a solution of an alkali metal hydroxide or alkaline earth metal hydroxide or a mixture thereof having a pH of 8 or higher and thus producing a mixed solution, and (ii) separating the solid components from the mixed solution.

In the method according to the invention, the separation of the solid gypsum components from the mixed solution is expediently carried out by filtering and, if necessary, pressing. The gypsum is obtained as the solid product of the method.

Prior to being treated by the inventive method the gypsum can advantageously be milled and sieved to remove excess fibers such as paper and/or glass fibers and metal parts as for example screws or other physically separable debris

The alkali metal and/or alkaline earth metal hydroxide used in the method can be any alkali metal or alkaline earth metal hydroxide commercially available in large quantities, although magnesium, sodium, potassium, and calcium hydroxide are preferred due to cost considerations. Most preferred is calcium hydroxide as it contains the same cation as gypsum, thus providing a relevant calcium ion concentration in the solution to counteract the dissolution of gypsum.

Regarding the alkali metal and/or alkaline earth metal hydroxide, it is not decisive whether it is used as such or whether the hydroxide is first produced by reacting an oxide, for example calcium oxide (CaO), with water to achieve and then mixing it with the aqueous gypsum suspension. The reaction of an alkali metal and/or alkaline earth metal oxide in water to produce a hydroxide might even be favorable, for example in the case of calcium oxide, because the reaction to its hydroxide is exotherm. The evolving heat can advantageously be used to speed up the inactivation reaction of the siliconate.

In the case that an alkali metal and/or alkaline earth metal hydroxide solution is used, a higher pH has a favorable effect on the reaction rate of siliconates. Therefore, in the context of the present invention it is preferred that the alkali metal and/or alkaline earth metal hydroxide solution has a pH of at least 9, and further preferred at least 10. It is particularly preferred if the alkali metal and/or alkaline earth metal hydroxide solution is a saturated solution, and in particular a saturated calcium hydroxide solution, since in this way on the one hand the reaction rate of siliconates can be maximized and on the other hand the solution of gypsum in the mixture can be minimized. Further preferred, the pH of the alkali metal or alkaline earth metal solution is below 12 and especially preferred below 11.5. If the pH of the hydroxide solution is higher than about 11.5, the foam efficiency seems to decrease. The term foam efficiency relates to the foam volume and foam stability of different samples when used with stucco made from gypsum treated according to the inventive method but with differing pH.

With regard to the concentration of the siliconates in the gypsum to be treated by the inventive method no relevant restrictions exist. The concentration of such siliconates is typically in the range of 0.1 to 10 wt. % and mostly in the range of about 0.5 to 5 wt. % or less, for example 0.1 to 1 wt.-%. Preferably, at least part of contained siliconates are hydrogen methyl siliconates. In this regard, it is noted that the terms “siliconate with Si—H bonds” and H-siliconate in this application are used interchangeably and have the same meaning.

The siliconate contained in the gypsum to be treated/recycled by the method according to the invention may be an oil or resin or a mixture thereof. In most cases, the siliconate is a siliconate with Si—H bonds of the following formula,

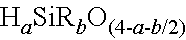

wherein
R denotes a monovalent, optionally halogen-substituted C₁-C₁₅ hydrocarbon or hydrocarbonoxy radical or hydroxyl groups,
a denotes 0, 1, 2 or 3, in particular 0.01 to 1.2, preferably 0.1 to 1, and
b denotes 0, 1, 2 or 3, in particular 1.0 to 2.0, preferably 1.4 to 1.8, with the proviso that at least one Si-bonded hydrogen atom is present per molecule.

Examples of the C₁-C₁₅ hydrocarbon radicals are alkyl radicals, e.g. in the form of methyl, ethyl, n-propyl, iso-propyl, n-butyl, iso-butyl, tert-butyl, n-pentyl, iso-pentyl, neo-pentyl. Preferred radicals R are non-substituted C₁-C₆ alkyl radicals, and the H-siloxane usually preferably has at least methyl groups or is present in the form of hydrogen methyl siliconates.

The stirring in the context of the described method does not require any special conditions. However, a higher pH value of the alkali metal and/or alkaline earth metal hydroxide solution, and/or higher temperatures accelerate the inactivation of siliconates. On the other hand, in order to make the method economically useful and to ensure that a larger proportion of the gypsum does not dissolve in the stirred mixture, stirring is preferably carried out at room temperature or at an elevated temperature of above room temperature and up to 100° C., preferably the temperature is between room temperature and 60° C.

The period of stirring is also not subject to any relevant restrictions and can be chosen with respect to the amount of siliconate contained in the starting material and the stirring temperature. A period of 5 to 180 min and preferably 15 to 120 min and further preferred 30 to 120 min is regarded as suitable in the sense of a favorable economic efficiency of the method. As a general rule, the lower the time needed to achieve sufficient siliconate inactivation the better in terms of process and economic efficiency.

The solid product obtained by the separation step is essentially gypsum. For further processing, it may be useful to subsequently dry this gypsum (e.g. for storage), and/or to thermally convert it into stucco, mainly consisting of calcium sulfate hemihydrate (CaSO₄ ½ H₂O) and to a lesser degree calcium sulfate anhydrite (CaSO₄ anhydr.). Accordingly, it is preferred that the solid components separated from the method are subjected to drying step and/or a calcination step or a thermal treatment step in general. According to one embodiment, the solid components are treated such that the resulting product is composed of at least 80% by weight, and further preferably at least 90% by weight, of calcium sulfate hemihydrate except for non-calcium sulfate impurities. For conversion to the hemihydrate, the solid products can for example be dried and calcined for about 2 h at about 160° C. According to another embodiment, the solid components are treated such that the resulting calcium sulfate product is composed of at least 80% by weight, and more preferably at least 90% by weight, of calcium sulfate anhydrite. The treatment temperature is higher than for the production of the hemihydrate, e.g. in the range of 200 to 1000° C.

Advantageously, the solution of alkali metal and/or alkaline earth metal hydroxide used for the treatment of the gypsum with a content of siliconates can be re-used after the separation of the solid components. The recycled alkali metal and/or alkaline earth metal hydroxide solution can be added to another batch of gypsum and fed to another treatment according to the inventive method. If the pH value of the solution has been noticeably reduced by the treatment (i.e. by a value of 0.2 or more), further alkali metal and/or alkaline earth metal hydroxide can be added for regeneration.

Another aspect of the present invention relates to a gypsum obtainable or produced by the method as described above.

A still further aspect of the present invention relates to a method for preparing a foamed gypsum composition, which comprises adding a foaming agent to a stucco slurry and generating a foam from the composition, or generating a foam from the foaming agent and water and adding the foam to stucco or a stucco slurry (suspension of calcium sulfate in water) to obtain a foamed gypsum composition, wherein the stucco is produced by calcining a gypsum that has been treated by the method as described above. Accordingly, this method comprises at least three steps, namely treating a gypsum as in the foregoing method, calcining the gypsum thus treated and subjecting the resulting stucco to a method for producing a foamed gypsum composition. This procedure avoids the disadvantageous effects of reduced foam stability observed when gypsum recyclate containing siliconates, or gypsum contacted with such siliconate is processed to a foamed body. It is irrelevant whether the foamed gypsum composition is prepared by foaming a mixture of all ingredients in water, or whether an aqueous foam is prepared from foaming agents and water in advance, and then mixed with stucco and water or a stucco slurry to produce the foamed gypsum composition in this way.

The foamed stucco compositions prepared by this method preferably have a ratio of solid components to gas such that, after curing and drying of the composition, a bulk density of the foamed gypsum composition in the range of 300 to 800 kg/m³ and in particular in the range of 550 to 750 kg/m³ is obtained.

According to a preferred embodiment the foamed calcium sulfate slurry is (continuously) cast to form planar substrates, for example plasterboards, as known in the art. The plasterboards preferably are enclosed by a liner made from paper or veil, the veil typically being mainly inorganic fiber mats. For this purpose, the stucco slurry is cast onto a liner, and the cast stucco slurry preferably is covered with another liner. After casting the planar substrates are preferably subjected to a curing and optionally a drying step resulting in the foamed gypsum composition.

Another aspect of the invention is a gypsum board produced by the method described above, preferably in the form of gypsum plasterboard.

Finally, another aspect of the present invention concerns the use of an alkali metal and/or alkaline earth metal hydroxide solution having a pH of 8 or higher for the inactivation of siliconates in gypsum recyclates wherein a gypsum suspension is stirred with the alkali metal and/or alkaline earth metal hydroxide solution. The solution used in this application is preferably a saturated calcium hydroxide solution.

Gypsum recyclates differ from conventional gypsum, i.e. FGD gypsum or quarry gypsum, in that they contain components that are usually included in processed gypsum products. According to the invention, the gypsum recyclate contains siliconates or is a gypsum product obtained by reaction with siliconates.

### BRIEF DESCRIPTION OF THE DRAWING

The present invention is further described with reference to several examples of embodiments which, however, are intended solely to illustrate the invention and are not in any way to be construed as limiting the scope of protection of the invention.

FIG. 1 graphically shows the results of Table 1.

### DESCRIPTION OF THE INVENTION

### Example 1

Gypsum samples with a fixed amount of H-siloxane of 0.5 and 1.0 wt.-% with respect to the amount of gypsum were prepared by addition of the respective amounts of H-siloxane to the gypsum.

A saturated solution of calcium hydroxide was prepared by stirring such an amount of calcium hydroxide in water that after stirring there is still a discernible bottom residue. The thus obtained mixture is filtered and added to gypsum samples with or without added H-siloxane. The thus obtained mixture is stirred at a temperature of 50 to 60° C. for 120 minutes. Thereafter, the solid material is filtered off and the calcium hydroxide solution is pressed out of the residue. From this material, settable gypsum (stucco) is obtained by drying and calcination for about 2 h at 160° C.

For foam stability tests, 1 g samples of each the thus obtained stucco, the respective stucco without treatment with saturated calcium hydroxide solution and stucco made from conventional gypsum were mixed with a foam made from a defined amount of foaming agent and water. The volume of the mixture of foam and stucco is determined directly after mixing, i.e. it represents the maximum volume of the individual sample. For comparison, a sample without the addition of any stucco was prepared (reference), i.e. the sample contained only foam. The time elapsed until 50 ml and 100 ml water are drained from the foam due to its collapse was determined for each sample.

The results of these tests are shown in the below Table 1:

| | Volume | Time until 50 ml | Time until 100 ml |
|---|---|---|---|
| | [ml] | [min] | [min] |
| reference | 917 | 2:11 | 3:35 |
| stucco | 842 | 2:13 | 3:11 |
| stucco with 0.5% H- | 550 | 1:21 | 2:15 |
| siloxane/untreated | | | |
| stucco with 0.5% H- | 766 | 1:46 | 2:56 |
| siloxane/treated | | | |
| stucco with 1% H- | n.d. | n.d. | n.d. |
| siloxane/untreated | | | |
| stucco with 1% H- | 717 | 1:48 | 2:50 |
| siloxane/treated | | | |

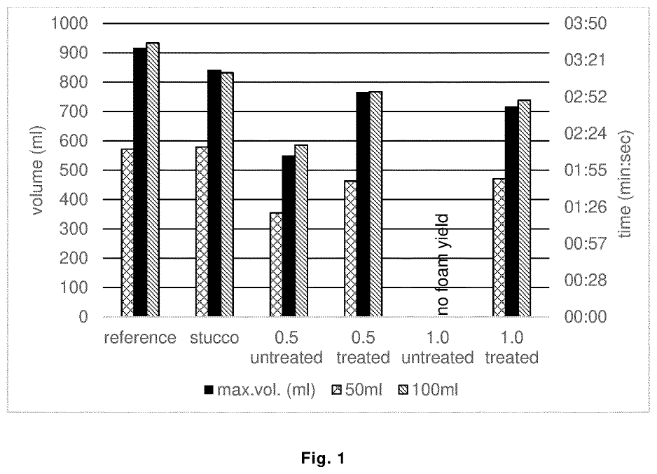

FIG. 1 graphically shows the results of Table 1. The left-hand axis shows the maximum volume of the mixture of foam and respective stucco, depicted in black. The right-hand axis shows the time elapsed until 50 ml and 100 ml water were drained from the collapsing foam, respectively. It refers to the patterned columns of the chart. The numbers on the X-axis refer to the concentration of siloxane contained in the respective sample, whereas the labels “treated” and “untreated” refer to the fact that stucco treated according to invention or untreated stucco was used.

As can be seen from the above table and FIG. 1 the presence of H-siloxanes significantly decreases the foam stability. The untreated sample containing 1 wt.-% H-Siloxane even showed no volume increase after foam addition. The foam added collapsed instantly so that there was only the volume increase due to the addition of the water used to form the foam. An improvement of the foam stability was observed in all cases where the gypsum was previously treated with saturated calcium hydroxide solution. The improvement is discernable by the longer time interval elapsed until a predetermined amount of foam is collapsed and the higher maximal foam volume at the beginning of the measurement.

### Example 2

Gypsum containing 0.5 wt.-% and 1 wt.-% of H-siloxane, treated with calcium hydroxide and untreated, respectively, were calcined to achieve stucco. From the stucco so achieved, sample bodies were prepared comprising 2.5 wt.-% of foam with respect to the amount of stucco and an amount of water as indicated in Table 2. After setting and drying, the bulk density of the sample bodies was determined. The results of these tests are provided in Table 2.

| | Water/stucco | Bulk density |
|---|---|---|
| Sample | ratio | [kg/m³] |
| REA Gypsum | 0.8 | 585.68 |
| Recycl. gypsum with 0.5% H- | 1.0 | 728.72 |
| siloxane/untreated | | |
| Recycl. gypsum with 0.5% H- | 1.0 | 502.52 |
| siloxane/treated | | |
| Recycl. gypsum with 1% H- | 1.0 | 723.28 |
| siloxane/untreated | | |
| Recycl. gypsum with 1% H- | 1.0 | 508.68 |
| siloxane/treated | | |

As is apparent from Table 2, the bulk density of the samples, where the gypsum was treated with calcium hydroxide before calcining it, was markedly lower than the bulk density obtained with the untreated samples and much closer to the bulk density of the gypsum benchmark.

1. A method for treating gypsum comprising siliconates, the treatment comprising the steps of:
(i) stirring an aqueous gypsum suspension with a solution of an alkali metal hydroxide or alkaline earth metal hydroxide or mixtures thereof having a pH of 8 or higher, thus producing a mixed solution, and
(ii) separating the solid components from the mixed solution.

2. The method according to claim 1, wherein calcium hydroxide is used as the alkaline earth metal hydroxide.

3. The method of claim 1, wherein the alkali metal hydroxide or alkaline earth metal hydroxide solution of the mixture thereof has a pH of at least 9 and preferably at least 10 and is further preferably a saturated alkaline earth metal hydroxide solution or wherein the alkali metal hydroxide or alkaline earth metal hydroxide solution has a pH of less than 12, preferably less than 11.5.

4. The method of claim 3, wherein the saturated alkaline earth metal hydroxide solution is a calcium hydroxide solution prepared by adding calcium hydroxide or calcium oxide to water.

5. The method according to claim 1, wherein the stirring is carried out at room temperature or an elevated temperature of above room temperature and up to 60° C.

6. The method according to claim 1, wherein the stirring is carried out for a period of 5 to 180 min and preferably 15 to 120 min, further preferred 30 to 120 min.

7. The method according to claim 1, further comprising a drying step and/or a calcination step.

8. The method according to claim 1, wherein the solution of alkali metal or alkaline earth metal hydroxide or the mixture thereof is used for a subsequent treatment of a further gypsum batch after separation of the solid constituents, wherein further alkali metal or alkaline earth metal hydroxide or a mixture thereof is optionally added for regeneration.

9. A method for preparing a foamed gypsum composition comprising adding a foaming agent to a stucco slurry and generating a foam from the composition or generating a foam from the foaming agent and water and adding the foam to stucco or a stucco slurry to obtain a foamed stucco composition, wherein the stucco is produced by calcining a gypsum that has been treated by a method according to claim 1.

10. The method according to claim 9, wherein the foamed gypsum composition contains gas bubbles in an amount to provide a bulk density after drying in the range of 300 to 800 kg/m3 and preferably in the range of 550 to 750 kg/m3.

11. A method according to claim 9, further comprising a step of casting a foamed stucco composition to form a planar substrate and allowing the stucco composition to cure resulting in the foamed gypsum composition.

12. A method according to claim 11, wherein the foamed calcium sulfate slurry is cast onto a liner, and wherein the cast calcium sulfate slurry preferably is covered with another liner.

13. A gypsum produced by a method according to claim 1.

14. A gypsum board produced by a method according to claim 9.

15. (canceled)
